(19) United States
(12) Patent Application Publication
(10) Pub. No.: US 2025/0209195 A1
(43) Pub. Date: Jun. 26, 2025

(54) INFORMATION PROCESSING DEVICE AND INFORMATION PROCESSING METHOD

(71) Applicant: TOYOTA JIDOSHA KABUSHIKI KAISHA, Toyota-shi (JP)

(72) Inventors: Takaaki NAGATANI, Okazaki-shi (JP); Toshio HAMADA, Toyota-shi (JP); Keita NOZAKI, Toyota-shi (JP)

(73) Assignee: TOYOTA JIDOSHA KABUSHIKI KAISHA, Toyota-shi (JP)

(21) Appl. No.: 18/883,074

(22) Filed: Sep. 12, 2024

(30) Foreign Application Priority Data
Dec. 22, 2023 (JP) 2023-217389

(51) Int. Cl. G06F 21/62

(52) U.S. Cl. CPC G06F 21/6218

(57) ABSTRACT

The information processing device includes a control unit configured to: acquire first data; generate second data by performing first processing on the first data; determine whether the user is a first user whose access to the second data is not restricted or a second user whose access to at least a part of the second data is restricted; and, if the user determines that the user is the first user, transmit second data to a terminal associated with the first user, and if the user determines that the user is the second user, perform second processing on the second data, thereby converting the second data into third data that is data that does not include data whose access is restricted, and transmit the third data to the terminal associated with the second user.

### CROSS-REFERENCE TO RELATED APPLICATION

This application claims priority to Japanese Patent Application No. 2023-217389 filed on Dec. 22, 2023, incorporated herein by reference in its entirety.

### BACKGROUND

### 1. Technical Field

The present disclosure relates to processing of data.

### 2. Description of Related Art

There are many known techniques for processing data in accordance with demand. In this regard, for example, Japanese Unexamined Patent Application Publication No. 2023-074377 (JP 2023-074377 A) discloses a data processing device including a computing device or the like that determines a usage application of data, determines a degree of demand for processing when there is a need to perform processing on a plurality of pieces of data for different usage applications in a same time period, and processes the data in order from data with a high degree of demand for processing.

### SUMMARY

An object of the present disclosure is to achieve both speed and security in data provision.

An aspect of an embodiment of the present disclosure is an information processing device including a control unit that executes acquiring first data collected via an in-vehicle network, generating second data by performing first processing on the first data, determining, in response to a request for providing data from a terminal associated with a user, whether the user is a first user of which access to the second data is not restricted, or a second user of which access to at least part of the second data is restricted, transmitting the second data to a terminal associated with the first user when determination is made that the user is the first user, and performing, when determination is made that the user is the second user, second processing on the second data to convert the second data into third data that is data not including data regarding which the access is restricted and transmitting the third data to a terminal associated with the second user.

Also, an aspect of an embodiment of the present disclosure is an information processing method including acquiring first data collected via an in-vehicle network, generating second data by performing first processing on the first data, determining, in response to a request for providing data from a terminal associated with a user, whether the user is a first user of which access to the second data is not restricted, or a second user of which access to at least part of the second data is restricted, transmitting the second data to a terminal associated with the first user when determination is made that the user is the first user, and performing, when determination is made that the user is the second user, second processing on the second data to convert the second data into third data that is data not including data regarding which the access is restricted and transmitting the third data to a terminal associated with the second user.

Other aspects include a method that is executed by the above device, a program for causing a computer to execute the method, and a computer-readable storage medium storing the program in a non-transitory manner.

According to the present disclosure, both speed and security can be achieved in data provision.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an outline of processing executed by a server device according to an embodiment;

FIG. 2 is a diagram illustrating components included in the server device according to the embodiment;

FIG. 3 is a flow chart of a processing executed by a control unit of the server device according to the embodiment; and

FIG. 4 is a flowchart of processing for determining a first user and a second user executed by a control unit of the server device according to the embodiment.

### DETAILED DESCRIPTION OF EMBODIMENTS

Devices for processing data are known.

For example, a case where various kinds of data are acquired from the vehicle 10 will be considered. First, the apparatus communicates with the vehicle 10 and acquires various types of data on the in-vehicle network. Then, the apparatus processes various data as necessary. For example, the apparatus processes the acquired data into a data format that can be processed by various apparatuses, or deletes or masks information that is not suitable for providing personal information or the like to a person who is not authorized to browse. At this time, the apparatus starts processing of data processing when a demand for data provision occurs.

However, when the device performs processing of data processing each time a demand for data provision occurs, there is a possibility that duplicate processing is performed or that time required for data processing is increased. Therefore, there is a problem that it is not possible to smoothly provide data requiring prompt data provision. In addition, there is also a need to perform appropriate processing according to the access authority of the user of the data providing destination, while securing the speed of providing data that needs to be provided promptly.

In order to deal with such a problem, it is preferable that the apparatus collectively performs necessary processing for the user of the data providing destination, and individually determines whether or not processing is performed for each user with respect to data to which access restriction is imposed.

The information processing device according to the present embodiment solves such a problem.

An information processing device according to the one aspect of the present disclosure includes a control unit that executes acquiring first data collected via an in-vehicle network, generating second data by performing first processing on the first data, determining, in response to a request for providing data from a terminal associated with a user, whether the user is a first user of which access to the second data is not restricted, or a second user of which access to at least part of the second data is restricted, transmitting the second data to a terminal associated with the first user when determination is made that the user is the first user, and performing, when determination is made that the user is the second user, second processing on the second data to convert the second data into third data that is data not including data regarding which the access is restricted and transmitting the third data to a terminal associated with the second user.

The first user is typically a user whose access to the second data is not restricted. The first user is a user who can access all the data included in the second data. The first user is, for example, a user who can also access data whose access is restricted by a specific user such as personal information.

The second user is typically a user whose access to at least a portion of the second data is restricted. The second user is a user who cannot access data included in the second data and permitted to be accessed only by some users such as personal information.

The first data is data obtained from the in-vehicle network and before the first processing is performed.

The first processing is a processing performed on the first data. The first processing is a processing that is commonly required when the first user and the second user use data. The first processing may be, for example, processing such as data shaping processing or data format conversion.

The second data is data obtained by performing processing (first processing) that is commonly required when the first user and the second user use the data with respect to the first data.

The second processing is typically a processing of removing, from the second data, information whose access is restricted by the second user.

The third data is, for example, data obtained by performing processing (second processing) on the second data except for information whose access is restricted by the second user.

The second processing may be, for example, a processing of deleting or masking data included in the second data, which is restricted in access to personal information or the like.

When determining that the user is the first user, the control unit transmits the second data to the terminal associated with the first user. When determining that the user is the second user, the control unit performs the second processing on the second data to generate the third data, and transmits the third data to the terminal associated with the second user. Therefore, the control unit can switch whether or not the processing of the data to which the access restriction is imposed is performed according to the type of the user.

Accordingly, the information processing device according to the present disclosure can increase the data providing speed and secure data security according to demand.

In addition, in the first process, the control unit may generate the second data by processing the first data so as to be available at least at a terminal associated with the first user and a terminal associated with the second user.

Thus, the information processing device according to the present disclosure can collectively perform data processing that is commonly required when the first user and the second user use data. Therefore, there is a possibility that the information processing device according to the present disclosure can prevent an increase in the time required for providing data to a user.

Further, the control unit may determine that the user is the first user when the user is included in a list of users whose access to the second data is not restricted, and determine that the user is the second user when the user is not included in a list of users whose access to the second data is not restricted.

Thus, the information processing device according to the present disclosure can switch the execution of the processing of the data to which the access restriction is imposed according to the presence or absence of the access restriction of the user.

The control unit may generate the third data by deleting or masking, from the second data, information whose access by the second user is restricted in the second processing.

As a result, the information processing device according to the present disclosure can provide the corresponding user with information that does not include the information whose access is restricted by the user in the second data.

The step to which the information processing method concerning this disclosure acquires the first data collected via an in-vehicle network. The step which generates the second data by performing the 1st processing to the first data. In response to the request of provision of the data from a user's terminal, the aforementioned user. The 1st user whose access to the second data is not restricted, or the step which judges whether it is any of the 2nd users whose access to at least a part of the second data is restricted. When it judges with the aforementioned user being the first user, the second data is transmitted to the terminal related with the first user and it judges with the aforementioned user being the second user, by performing the 2nd processing to the second data, the second data is converted to the 3rd data which is the data in which the access was restricted, and it is related with the second user and transmitting the third data.

Thus, the information processing method according to the present disclosure can achieve the same effects as those of the information processing device described above.

Hereinafter, embodiments of the present disclosure will be described with reference to the drawings. A hardware configuration, a module configuration, a functional configuration, etc., described in each embodiment are not intended to limit the technical scope of the disclosure to them only unless otherwise stated.

### Embodiment

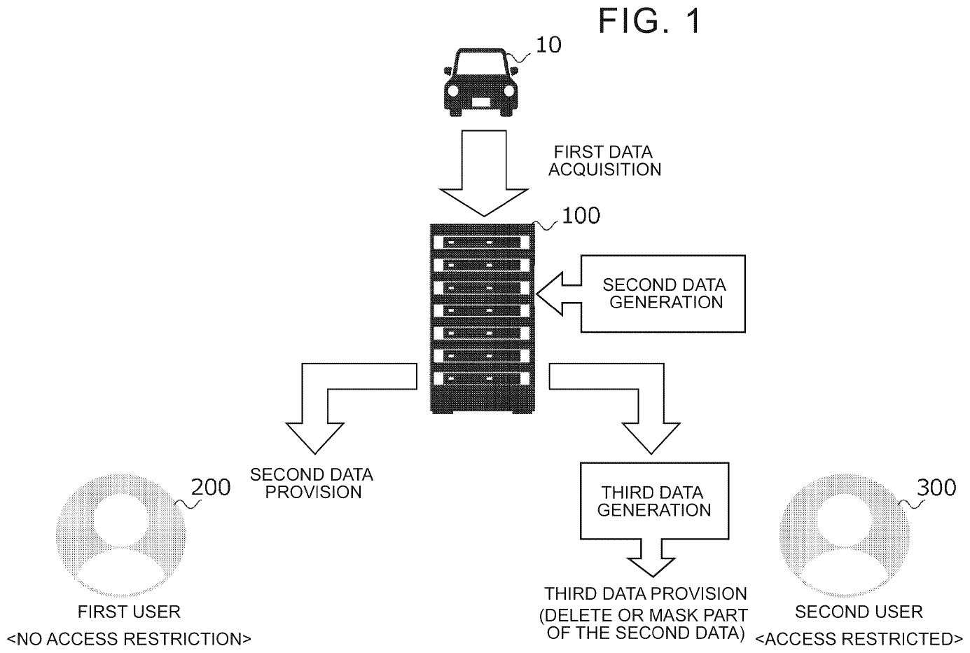

An outline of processing performed by the server device according to the embodiment will be described with reference to FIG. 1. FIG. 1 is a diagram illustrating an outline of processing executed by a server device 100 according to an embodiment. Here, the server device 100 is an example of an information processing device according to the present disclosure. The server device 100 acquires various types of data from the vehicle 10, processes the acquired data as appropriate, and provides the processed data to the user. The server device 100 is configured to be able to communicate with the vehicle 10 and a terminal associated with the user.

First, the server device 100 communicates with the vehicle 10 and acquires first data that is various data on the in-vehicle network of the vehicle 10. The various types of data may include, for example, an identifier of a user of the vehicle 10, a speed of the vehicle 10, a destination, a travel history, and the like.

Next, the server device 100 generates second data that is data obtained by converting the acquired first data into a format usable by the user's terminal. Since the first data is data generated by a sensor, an ECU, or the like that flows on the in-vehicle network of the vehicle 10, the terminal of the user cannot directly browse the first data. The second data includes personal information such as an identifier of a user of the vehicle 10, a travel history, and the like as it is, in addition to various travel data.

Next, the server device 100 determines whether the user who is the target of providing the data is the first user 200 whose access to the second data is not restricted or the second user 300 whose access to the second data is restricted. Here, the first user 200 is typically a user such as a connected car, and is a user who desires to provide data such as travel information such as vehicle speed, as necessary. The second user 300 is typically a user who develops a system using travel data or the like of the vehicle 10, and is a user who requests data provision for use in system development.

When the server device 100 determines that the user is the first user 200, the second data is directly provided to the terminal associated with the first user 200. The server device 100 provides the second data to the first user 200 without performing new processing on the second data, and thus can provide the data quickly.

When the server device 100 determines that the user is the second user 300, the server device generates the third data in which the item of the information whose access is restricted by the second user 300 is deleted or masked out of the second data. Then, the server device 100 provides the terminal associated with the second user 300 with the third data instead of the second data.

As described above, the server device 100 switches whether or not to execute processing of data to which access restriction is imposed, depending on whether or not the user is restricted in access. As a result, the server device 100 can quickly provide data for which the speed of providing is required, and can process and provide items for which access restrictions are set for data for which security is required.

According to this configuration, the server device 100 can increase the data providing speed and secure the data security according to the demand.

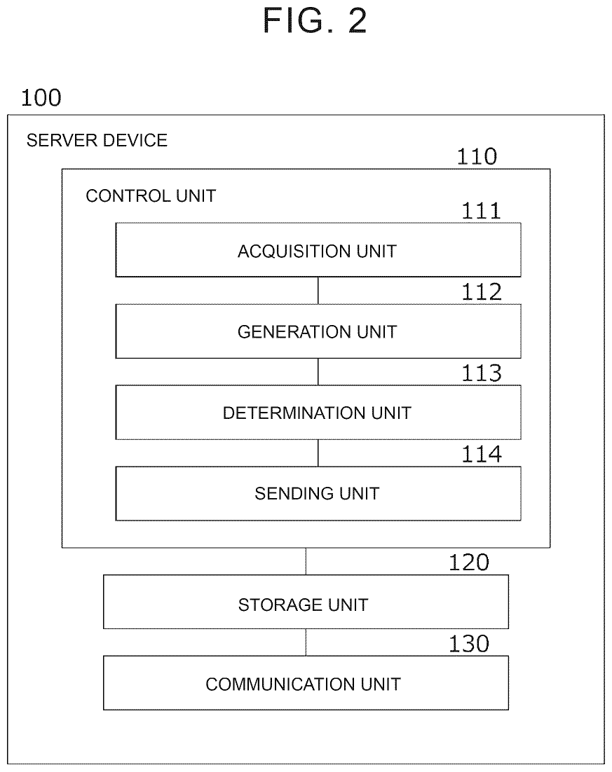

Next, each element constituting the system will be described in detail. FIG. 2 is a diagram for describing components included in the server device 100 according to the embodiment.

The server device 100 according to the present embodiment includes a control unit 110, a storage unit 120, and a communication unit 130.

The control unit 110 is implemented by a processor such as a central processing unit (CPU) or a graphics processing unit (GPU) and a memory. The control unit 110 includes an acquisition unit 111, a generation unit 112, a determination unit 113, and a transmission unit 114 as functional modules. These functional modules may be realized by executing a program by the control unit 110.

The acquisition unit 111 acquires, from the vehicle 10, first data that is various data on the in-vehicle network of the vehicle 10. The various types of data may include, for example, an identifier of a user of the vehicle 10, a speed of the vehicle 10, a departure point and a destination, a number of brakes, a video of an in-vehicle camera, a travel history, and the like. The acquisition unit 111 communicates with the vehicle 10 via a communication unit 130, which will be described later, and acquires the first data.

The generation unit 112 generates the second data by performing the first processing on the first data. Here, the first process is a process of processing the first data so as to be available to a terminal associated with a user who is a target for providing the data. The second data is, for example, data in a format available at a terminal associated with each of the first user 200 and the second user 300.

In addition, when the determination unit 113, which will be described later, determines that the user is the second user 300, the generation unit 112 performs the second processing on the second data to convert the second data into the third data. Here, the second processing is a processing of deleting or masking an item of information whose access is restricted by the second user 300 from the second data. The third data is data generated based on the second data and not including data whose access is restricted by the second user 300.

The determination unit 113 determines whether the user is the first user 200 or the second user 300. Here, the first user 200 is a user whose access to the second data is not restricted, and the second user 300 is a user whose access to at least part of the second data is restricted. The determination unit 113 performs the above-described determination when there is a request to provide the second data from the terminal associated with the user. Specifically, the determination unit 113 may determine the user as the first user 200 when the user who has transmitted the request for providing the second data is included in the list of users whose access to the second data is not restricted. In addition, when the user who has transmitted the request for providing the second data is not included in the list of users whose access to the second data is not restricted, the determination unit 113 may determine the user as the second user 300.

The transmission unit 114 transmits the second data to the terminal associated with the first user 200. Then, the transmission unit 114 transmits the third data to the terminal associated with the second user 300. The transmission unit 114 communicates with a terminal associated with the first user 200 or a terminal associated with the second user 300 via a communication unit 130, which will be described later, and transmits target data.

The storage unit 120 is an auxiliary storage device such as a main storage device such as a RAM or a ROM, a EPROM, a hard disk drive, and a removable medium. The secondary storage device stores an operating system (OS), various programs, various tables, and the like, and by executing the programs stored therein, it is possible to realize the respective functions matching the predetermined objectives of the respective units of the control unit 110. However, some or all of the functions may be implemented by a hardware circuit such as an ASIC or an FPGA.

The storage unit 120 stores data or the like used or generated in processing performed by the control unit 110. The storage unit 120 may temporarily store the first data acquired from the vehicle 10.

The communication unit 130 includes a communication circuit that performs wireless communication. The communication unit 130 may be, for example, a communication circuit that performs wireless communication using 4th Generation (4G) or a communication circuit that performs wireless communication using 5th Generation (5G). The communication unit 130 may be a communication circuit that performs radio communication using Long Term Evolution (LTE) or a communication circuit that performs communication using Low Power Wide Area (LPWA). Further, the communication unit 130 may be a communication circuit that performs radio communication using Wi-Fi (registered trademark).

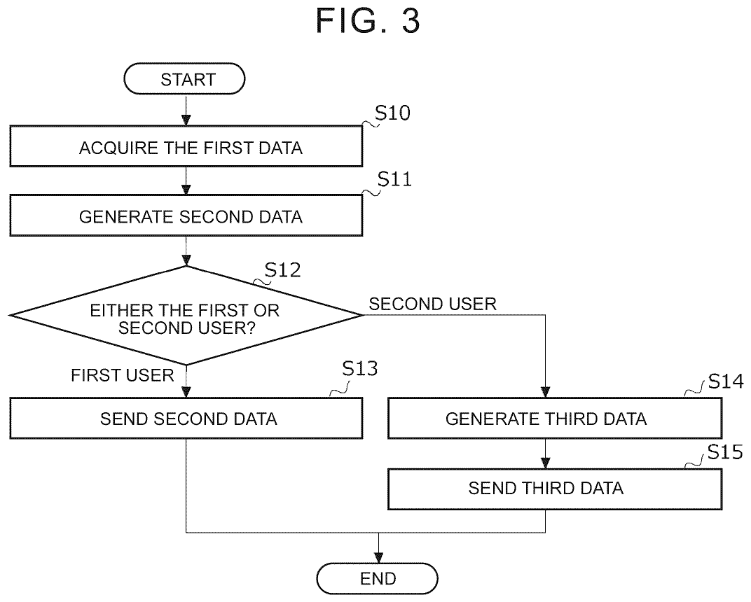

Next, specific contents of the processing performed by the server device 100 will be described. FIG. 3 is a flowchart of processing executed by the control unit 110 of the server device 100 according to the embodiment.

For example, in a case where a request for providing data is received from a terminal associated with a user, the server device 100 may start the processing illustrated in FIG. 3.

First, in S10, the acquisition unit 111 acquires the first data from the vehicle 10. The acquisition unit 111 communicates with the vehicle 10 via the communication unit 130, and acquires first data including travel data of the vehicle 10, user information of the vehicle 10, and the like.

Next, in S11, the generation unit 112 performs a first processing on the first data and generates second data. Specifically, the generation unit 112 may generate the second data by processing the first data so as to be available to at least the terminal associated with the first user 200 or the terminal associated with the second user 300.

The first processing may specifically include flattening the hierarchical data, deleting rows without values, deleting unnecessary labels, removing outliers or removing outliers of latitude and longitude data, correcting time stamps, and aggregating or deleting duplicate data. Further, the first process may further include processing such as conversion of label names, deletion of abnormal values, linear interpolation of data and left-right inversion processing of data, zero point correction, and data shaping processing such as smoothing processing, or format conversion of data. The terminal associated with the user cannot directly view the first data itself, but only can view the second data after the first processing is performed on the first data.

Next, in S12, the determination unit 113 determines one of the first user 200 and the second user 300 by the user. As described above, the first user 200 is a user whose access to the second data is not restricted. As described above, the second user 300 is a user whose access to at least a part of the second data is restricted.

If it is determined in this step that the user is the first user 200, the processing transitions to S13.

If it is determined in this step that the user is the second user 300, the processing transitions to S14.

When the processing transitions to S13, the transmission unit 114 transmits the second data to the terminal associated with the first user 200. The transmission unit 114 transmits the second data to the terminal associated with the first user 200 via the communication unit 130.

When the processing transitions to S14, the generation unit 112 performs a second processing on the second data and generates third data. Here, the second processing is a processing of converting the second data into third data that is data that does not include information whose access by the second user 300 is restricted. Specifically, the generation unit 112 may delete or mask the information whose access is restricted by the second user 300 from the second data.

In S14, by generating the third data each time in response to a request from the user, it is possible to reduce the capacity of the storage unit 120 that stores the third data.

Next, at S15, the transmission unit 114 transmits the third data to the terminal associated with the second user 300. The transmission unit 114 transmits the third data to the terminal associated with the second user 300 via the communication unit 130.

As a result, the server device 100 can collectively perform processing that is commonly required for the user of the data providing destination on the acquired data. Then, the server device 100 can switch whether or not to perform processing on the data for which the access restriction is set, based on the presence or absence of the access restriction by the user. That is, the server device 100 can quickly provide data for which the speed of providing speed is required, and can provide data for which measures against personal information and the like are required after data processing is performed. Therefore, the server device 100 can increase the data providing speed and secure the data security according to the demand.

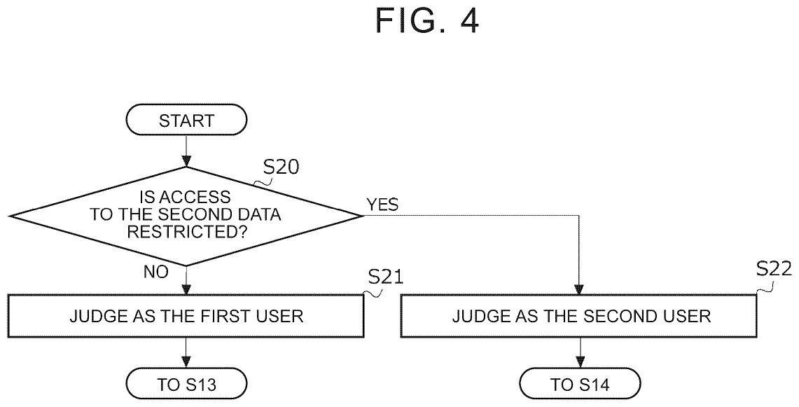

Next, a processing in which the determination unit 113 of the control unit 110 of the server device 100 determines the type of the user will be described. FIG. 4 is a flowchart of processing for determining the first user 200 and the second user 300 executed by the control unit 110 of the server device 100 according to the embodiment. The processing illustrated in FIG. 4 is a detailed description of the processing of S12 described in FIG. 3.

First, in S20, the determination unit 113 determines whether or not the user who has transmitted the data provision request is restricted from accessing the second data. In this step, when the determination unit 113 determines that the user is restricted from accessing the second data, an affirmative determination is made.

For example, when the user who has transmitted the data provision request is included in the list of users whose access to the second data is not restricted, which is referred to by the determination unit 113, the user may determine that the user is the first user 200. When the user is not included in the list of users whose access to the second data is not restricted, which is referred to by the determination unit 113, the user may determine that the user is the second user 300. The acquisition unit 111 may acquire a list of users whose access to the second data is not restricted, which is stored in an external device. Further, the storage unit 120 may store the list acquired by the acquisition unit 111. Then, the determination unit 113 may refer to the list stored in the storage unit 120.

If an affirmative determination is made in this step, the processing transitions to S22.

If a negative determination is made in this step, the processing transitions to S21.

When the processing transitions to S21, the determination unit 113 determines the user as the first user 200. Thereafter, the processing transitions to S13 of FIG. 3.

When the processing transitions to S22, the determination unit 113 determines that the user is the second user 300. Thereafter, the processing transitions to S14 of FIG. 3.

Accordingly, the server device 100 can switch the execution of the processing of the data to which the access restriction is imposed according to the presence or absence of the access restriction of the user.

### Modified Examples

The above-described embodiment is merely an example, and the present disclosure may be appropriately modified and implemented without departing from the scope thereof.

For example, the processing and means described in the present disclosure can be freely combined and implemented as long as no technical contradiction occurs.

Further, the processing described as being executed by one device may be shared and executed by a plurality of devices. Alternatively, the processing described as being executed by different devices may be executed by one device. In the computer system, it is possible to flexibly change the hardware configuration (server configuration) for realizing each function.

The present disclosure can also be implemented by supplying a computer with a computer program that implements the functions described in the above embodiment, and causing one or more processors of the computer to read and execute the program. Such a computer program may be provided to the computer by a non-transitory computer-readable storage medium connectable to the system bus of the computer, or may be provided to the computer via a network. The non-transitory computer-readable storage medium is, for example, a disc of any type such as a magnetic disc (floppy (registered trademark) disc, hard disk drive (HDD), etc.), an optical disc (compact disk read-only memory (CD-ROM), digital versatile disc (DVD), Blu-ray disc, etc.), a ROM, a random access memory (RAM), an erasable programmable read only memory (EPROM), an electrically erasable programmable read only memory (EEPROM), a magnetic card, a flash memory, an optical card, and any type of medium suitable for storing electronic commands.

What is claimed is:

1. An information processing device comprising a control unit that executes
acquiring first data collected via an in-vehicle network,
generating second data by performing first processing on the first data,
determining, in response to a request for providing data from a terminal associated with a user, whether the user is a first user of which access to the second data is not restricted, or a second user of which access to at least part of the second data is restricted,
transmitting the second data to a terminal associated with the first user when determination is made that the user is the first user, and
performing, when determination is made that the user is the second user, second processing on the second data to convert the second data into third data that is data not including data regarding which the access is restricted, and transmitting the third data to a terminal associated with the second user.

2. The information processing device according to claim 1, wherein the control unit, in the first processing, generates the second data by processing the first data so as to be usable by at least the terminal associated with the first user and the terminal associated with the second user.

3. The information processing device according to claim 1, wherein the control unit
determines the user to be the first user when the user is included in a list of users of which access to the second data is not restricted, and
determines the user to be the second user when the user is not included in the list of users of which access to the second data is not restricted.

4. The information processing device according to claim 1, wherein the control unit, in the second processing, generates the third data by deleting or masking information of which access by the second user is restricted, from the second data.

5. An information processing method comprising:
acquiring first data collected via an in-vehicle network;
generating second data by performing first processing on the first data;
determining, in response to a request for providing data from a terminal associated with a user, whether the user is a first user of which access to the second data is not restricted, or a second user of which access to at least part of the second data is restricted;
transmitting the second data to a terminal associated with the first user when determination is made that the user is the first user; and
performing, when determination is made that the user is the second user, second processing on the second data to convert the second data into third data that is data not including data regarding which the access is restricted, and transmitting the third data to a terminal associated with the second user.
